(19) United States
(12) Patent Application Publication
(10) Pub. No.: US 2014/0264156 A1
(43) Pub. Date: Sep. 18, 2014

(54) COMPOSITION FOR MINERAL SUPPLEMENT ANTICAKING AND DUST CONTROL

(71) Applicant: ECOLAB USA INC., Naperville, IL (US)

(72) Inventor: Daniel N. T. Hay, Naperville, IL (US)

(21) Appl. No.: 13/826,385

(22) Filed: Mar. 14, 2013

(51) Int. Cl. C09K 3/22

(52) U.S. Cl. CPC C09K 3/22
USPC 252/88.1

(57) ABSTRACT

The invention is directed towards methods and compositions for simultaneously preventing caking and dusting problems in mineral supplement. The method involves treating the mineral supplement with a composition comprising sorbitan N-esters (of fatty acids), mineral oil, and microcrystalline wax. This invention allows a user to solve two different problems each of which is often made worse by the cure for the other with a single composition. Best of all the single composition requiring minimal heating for application.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

The present invention relates generally to one or more methods, compositions of matter, and or apparatuses useful in preventing the caking of and in suppressing dust release from mineral supplement material.

Mineral supplement, like many hard crystalline materials tends to contain fines or to be friable and form fines, and these fines can be a dust releasing nuisance. Also, these materials tend to harden and form large, agglomerated masses due to a number of factors including exposure to moisture in humid environments, particularly during long periods of storage. These hardened masses are generally referred to as cakes. Some cake formations become very rigid and resistant to separation, making the mineral supplement very difficult to transport and to break apart when it needs to be applied.

In addition, economization and automation of processes for handling, transporting, and applying mineral supplement requires that it be in a form so that it can flow freely. In emptying storage containers containing tons of mineral supplement, for example, there is increased operational expense and potential danger on account of the tendency of the mineral supplement to cake. The mineral supplement cakes must be disintegrated by costly and cumbersome mechanical auxiliary apparatus in order to be emptied or loaded. Additionally, during commercial use of the mineral supplement, any step of dosing or mixing agglomerated or caked mineral supplement together with other substances can be difficult due to the extent of the caking.

In addition, the properties and end uses of mineral supplement further complicate this situation. Because mineral supplements are directly applied in open environments to plant life and those plants in turn may be consumed by animals or humans. As a result, many effective anticaking compositions such as ferrocyanides cannot be used because they are too toxic. Therefore it is important that the environmental and dietary safety of additives should be considered. In addition anticaking agents may not interact with the mineral supplement in any manner which would impair the benefit of the mineral supplement to the plant such as detrimentally changing pH or any other chemical property. As a result, compositions such as fatty amines and fatty acid salts are commonly used. However these compositions are less than ideal because of inherent hazards such as corrosive properties or because the compositions don't adequately address both anti-caking and anti-dust release simultaneously. Also these compositions can require cumbersome and dangerous heating systems just prior to their application.

As a result there is ongoing need and clear utility in a novel improved method and/or composition and/or apparatus for reducing caking and dust release from mineral supplement. The art described in this section is not intended to constitute an admission that any patent, publication or other information referred to herein is “Prior Art” with respect to this invention, unless specifically designated as such. In addition, this section should not be construed to mean that a search has been made or that no other pertinent information as defined in 37 CFR §1.56(a) exists.

### BRIEF SUMMARY OF THE INVENTION

At least one embodiment of the invention is directed towards a method of simultaneously reducing dust release and caking effects in a sample of mineral supplement. The method comprising the steps of contacting the mineral supplement with an effective amount of a composition comprising: sorbitan N-esters (of fatty acids), oil (including but not limited to mineral oil), and wax (including but not limited to microcrystalline wax).

The sorbitan N-esters (of fatty acids) may be selected from the list consisting of: sorbitan monostearate, sorbitan distearate, sorbitan tristearate, and any combination thereof. The sorbitan N-ester (of fatty acids) is up to 30% of the composition. The microcrystalline wax may be no more than 30% of the composition. The composition may be no less effective as a dust control agent than a similar composition that contains a more hydrophobic sorbitan than sorbitan N-stearate. The composition may be no less effective as a dust control agent than a similar composition that contains a more hydrophobic stearate than sorbitan N-stearate. The sorbitan N-esters (of fatty acids) may be sorbitan N-stearate. The sorbitan N-esters (of fatty acids) may be the reaction product of an esterification reaction using a stearic fatty acid.

### BRIEF DESCRIPTION OF THE DRAWINGS

A detailed description of the invention is hereafter described with specific reference being made to the drawings in which:

FIG. 1A is an illustration of dusting present in mineral supplement absent the inventive composition.

FIG. 1B is an illustration of the resolution of dusting and caking problems in in mineral supplement treated with the inventive composition.

FIG. 1C is an illustration of caking present in mineral supplement absent the inventive composition.

FIG. 2A is an illustration of caking occurring in an untreated control sample.

FIG. 2B is an illustration of the anti-caking effect of formulation I of the inventive composition.

FIG. 2C is an illustration of the anti-caking effect of formulation II of the inventive composition.

For the purposes of this disclosure, like reference numerals in the figures shall refer to like features unless otherwise indicated. The drawings are only an exemplification of the principles of the invention and are not intended to limit the invention to the particular embodiments illustrated.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Microcrystalline Wax” means a kind of wax which is a composition of matter characterized as being a refined mixture of solid, saturated aliphatic hydrocarbons, and produced by de-oiling certain fractions from the petroleum refining process. Microcrystalline waxes differ from refined paraffin wax in that the molecular structure is more branched and the hydrocarbon chains are longer (higher molecular weight). As a result the crystal structure of microcrystalline wax is much finer than paraffin wax, and this directly impacts many of the physical properties.

Microcrystalline waxes are tougher, more flexible and generally higher in melting point than paraffin wax. The fine crystal structure also enables microcrystalline wax to bind solvents or oil, and thus prevent the sweating-out (separation) of compositions. Also, microcrystalline waxes are generally darker, more viscous, denser, tackier and more elastic than paraffin waxes, and have a higher molecular weight and melting point. The elastic and adhesive characteristics of microcrystalline waxes are related to the non-straight chain components which they contain. Typical microcrystalline wax crystal structure is small and thin, making them more flexible than paraffin wax. Representative examples of microcrystalline waxes are defined as having specific testable properties for congeal point (ASTM D938), needle penetration (D1321), color (ASTM D6045), and viscosity (ASTM D445).

“Mineral Supplement” means a composition of matter characterized as being predominantly made up of materials which function as a form of animal feed and/or dietary supplement and/or nutritional supplement for consumption by an animal and/or which functions as a fertilizer for plants. Fertilizers are predominantly made up of inorganic substances, primarily salts and are in a form which increases the nutrients absorbed by plants. Fertilizers greatly affect the soil (its physical, chemical, and biologic properties) and plants. In soil, fertilizers undergo various changes that influence the solubility of their nutrients, their permeability, and their availability to plants. Fertilizers include direct plant nutrients (N, P, K, Mg, B, Cu, Mn) such as nitrogen fertilizers (ammonium, sodium, and calcium nitrates; ammonium sulfate; urea), phosphorus-supplying fertilizers (superphosphate, ground rock phosphate, ammonium and calcium phosphates), potassium fertilizers (potassium chloride, 30 and 40 percent potassium salt, potassium sulfates, potassium nitrate), and micronutrient fertilizers. Indirect fertilizers improve the agrochemical and physiochemical properties of soil and activate nutrients (for example, lime fertilizers and gypsum).

“Mineral Oil” means a kind of oil which is a composition of matter characterized as having an oily viscosity and being predominantly sourced from a non-vegetable (mineral) source, often they are a distillate of petroleum, are substantially colorless, and are substantially odorless, they may comprise a mixture of C15 to C40 (or higher) range alkanes and/or other carbon bearing groups, mineral oil includes but is not limited to white oil, liquid paraffin, paraffinic oils, naphthenic oils, and aromatic oils, and any combination thereof.

“Sorbitan” means a composition of matter which is an anhydride of sorbitol, any of a group of compounds that are cyclic ethers derived from sorbitol or its derivatives, and/or a mixture of isomeric organic compounds derived from the dehydration of sorbitol, sorbitan may have a chemical structure of:

[chemical structure]

as well as stereo isomers thereof.

“Sorbitan N-stearate” means a composition of matter which is an ester of sorbitan and/or sorbitol and its anhydrides with stearic acid and includes but is not limited to Sorbitan Monostearate, Sorbitan Distearate, and Sorbitan Tristearate.

“Sorbitan N-esters (of fatty acids)” means a composition of matter which is an ester of sorbitan and/or sorbitol and its anhydrides with a C6 to C30 fatty acid.

“Sorbitan Monostearate” means a composition of matter which may have a chemical structure of:

[chemical structure]

as well as stereo isomers thereof.

“Sorbitan Distearate” means a composition of matter which may have a chemical structure of:

[chemical structure]

as well as stereo isomers thereof.

“Sorbitan Tristearate” means a composition of matter which may have a chemical structure of:

[chemical structure]

as well as stereo isomers thereof.

“Stearic acid” means a composition of matter including the 18 carbon fatty carboxylic acid as well as other commercially available materials of variable composition containing the 18 carbon fatty acid together with other fatty acids of various carbon chain distributions. It is comprehensively described in Kirk-Othmer Encyclopedia of Chemical Technology, 4th Edition, (Published by Wiley, John & Sons, Inc.).

“Wax” means a substance which generally is a plastic solid at standard ambient temperature and which becomes a low viscosity liquid at moderately elevated temperatures, this definition includes the comprehensive description provided in Kirk-Othmer Encyclopedia of Chemical Technology, 4th Edition, pp. 615-626, (1998), (Published by Wiley, John & Sons, Inc.), wax includes but is not limited to insect wax, animal wax, beeswax, spermaceti, vegetable wax, carnuba wax, candelilla, Japan wax, quircury wax, rice-bran wax, jojoba, castor wax, bayberry wax, mineral wax, montan wax, peat wax, ceresin wax, ozokerite, petroleum wax, paraffin wax, microcrystalline wax, polyethylene wax, polymethylene wax, substituted amide wax, polymerized α-olefins, and any combination thereof.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

In at least one embodiment of the invention a composition of matter is added to a mineral supplement material. The composition comprises sorbitan N-esters (of fatty acids) such as sorbitan N-stearate, oil, and a wax. The oil may be mineral oil. The wax may be microcrystalline wax. The application of the composition both reduces the tendency of the mineral supplement material to cake and also reduces the tendency of the mineral supplement material to release dust. The relative amounts of the oil and wax are in proportions to maintain a homogeneous, stable, flowable blend. In at least one embodiment up to 30% of the composition is sorbitan N-stearate. In at least one embodiment up to 30% of the composition is wax (such as but not limited to microcrystalline wax). In at least one embodiment vegetable oil is used as the oil. In at least one embodiment the composition is a blend of the constituent materials. In at least one embodiment the composition is applied to the mineral supplement as a liquid. In at least one embodiment the composition is applied to the mineral supplement as a foam.

As illustrated in FIG. 1A a sample of mineral supplement granules produces large amounts of fugitive dust. This is because ultra-fine mineral supplement particles are so light that they can be suspended and travel aloft when contacted by moving air. Mineral supplement commonly becomes ultra-fine due to excessive grinding or due to attrition of the delicate mineral supplement masses during processing or handling.

FIG. 1C illustrates a sample of mineral supplement granules caking and therefore not passing through a feeder trough. Caking results from a number of factors including the hygroscopic nature of mineral supplement when in contact with moisture.

The effectiveness of the invention was quite surprising and in light of the teachings of the prior art the invention displays unexpected results. Because caking and dust release tend to be manifestations of diametrically opposite effects, there is no reason to expect that a single composition would resolve both problems. In fact one could expect that a dust control agent would hold the mineral supplement together better and exacerbate caking. And similarly one could expect that because an anti-caking agent reduces agglomeration, it would exacerbate dust release. Yet FIG. 1B illustrates how the invention simultaneously resolves both dust release and anti-caking effects.

In addition, the chemical properties of the constituents manifest unexpected results. Currently, in US Published Patent Application US 2006/0040049 a different stearate, calcium stearate is used to prevent anti-caking in potash. The anti-caking effect of calcium stearate relies in part upon the action of hydrophobic groups to repel water away from the potash and thereby prevent moisture based caking. In contrast the claimed compositions can be non-ionic in character. In at least one embodiment the composition excludes metallic salts of fatty acids. In at least one embodiment the composition excludes metallic stearates. In at least one embodiment the composition excludes any one or any more, and/or all of the stearates and/or one or more other compositions of matter described in US Published Patent Application US 2006/0040049.

In addition, the claimed stearate would be expected to exacerbate dust in mineral supplements, as they are typically a material whose form is that of a powdery solid. A dosage of sorbitan N-stearate however has fewer hydrophilic groups than calcium stearate yet when in the composition is better at preventing caking than the equivalent dosage of sorbitan N-stearate. In addition, in the absence of the microcrystalline wax and the mineral oil, sSorbitan N-stearate is a solid and in the absence of the microcrystalline wax and the mineral oil, would likewise be expected to exacerbate fugitive dust release. This is why different sorbitan esters such as polyoxyethylene sorbitan or ethoxylated sorbitan esters (polysorbates) which can be liquids at STP are used as dust control agents. This demonstrates that the composition displays a synergy that is greater than the sum of its parts.

Without being limited by a particular theory or design of the invention or of the scope afforded in construing the claims, it is believed that the anticaking and/or dust control effects of the individual constituent materials is effectively combined into a single composition that effectively controls both issues. The proportions of each constituent material afford a liquid blend composition that is uniform, able to flow, and stable against separation. Furthermore, minimal heating would be required for application of the composition, and the inherent hazards of the composition are reduced compared to other materials such as fatty amines. In the composition the reduced hydrophobic effect of sorbitan N-stearate's fewer hydrophobic groups (relative to calcium stearate) is more than compensated for by its interaction with the microcrystalline wax. The microcrystalline wax is itself very flexible and better interacts with the sorbitan N-stearate. The effect of the two together keeps the overall composition more intact (the oil phase does not “sweat out” of the composition) and therefore more effective than more hydrophobic stearates or more liquid sorbitans in the presence of other materials. The proportions of each constituent material afford a liquid blend composition that is uniform, able to flow, and stable against separation. Furthermore, minimal heating would be required for application of the composition, and the inherent hazards of the composition are reduced compared to other materials such as fatty amines.

### EXAMPLES

The foregoing may be better understood by reference to the following examples, which is presented for purposes of illustration and is not intended to limit the scope of the invention.

Laboratory analyses were conducted on samples of mineral oil, sorbitan monostearate, and microcrystalline wax containing formulations to reduce the caking and dusting tendency of potassium chloride, a potash mineral supplement/animal feed supplement prone to caking and dust formation. The results for sorbitan monostearate are representative of the expected results for all sorbitan N-esters (of fatty acids). The results for potassium chloride are representative of the expected results for all mineral supplements.

Anticaking data: Granular potassium chloride samples were subjected to conditions that would result in caking. Over 20 hours, samples were exposed to successive 75% then 20% relative humidity intervals at 30° C. with each humidity interval having a duration of 5 hours. Samples were then removed from test cells and placed on a 1 mm sieve. The sieve and a collection pan were loaded into a Ro-Tap sieve shaker and agitated for 10 seconds. Percent caking was calculated from the weight of material retained on the sieve relative to the entire sample tested. Results below indicate the reduction in caking by treatment of potassium chloride with 4 lb/ton of formulations containing mineral oil, sorbitan monostearate, and microcrystalline wax, labeled I and II. FIG. 2A illustrates the results on the untreated control. FIG. 2B illustrates the results on sample I and FIG. 2C illustrates the results on sample II.

| | Percent Caked (%) | |
|---|---|---|
| Treatment | Average Value | Standard Deviation |
| Untreated Control | 53.53 | 4.88 |
| I - 4 lb/ton | 27.07 | 0.93 |
| II - 4 lb/ton | 27.19 | 1.77 |

Dust control data: Granular potassium chloride was milled under controlled conditions to generate fugitive dust, which was quantified gravimetrically. Results below indicate the reduction in fugitive dust by treatment of potassium chloride with 2 lb/ton of samples I or II.

| | Fugitive Dust (ppm) | |
|---|---|---|
| Treatment | Average Value | Standard Deviation |
| Untreated Control | 4462 | 38.18 |
| I - 2 lb/ton | 1053 | 25.46 |
| II - 2 lb/ton | 1022 | 32.53 |

While this invention may be embodied in many different forms, there described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and/or incorporated herein. In addition the invention encompasses any possible combination that also specifically excludes any one or more of the various embodiments described herein and/or incorporated herein.

The above disclosure is intended to be illustrative and not exhaustive. This description will suggest many variations and alternatives to one of ordinary skill in this art. The compositions and methods disclosed herein may comprise, consist of, or consist essentially of the listed components, or steps. As used herein the term “comprising” means “including, but not limited to”. As used herein the term “consisting essentially of” refers to a composition or method that includes the disclosed components or steps, and any other components or steps that do not materially affect the novel and basic characteristics of the compositions or methods. For example, compositions that consist essentially of listed ingredients do not contain additional ingredients that would affect the properties of those compositions. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of I and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure. Weight percent, percent by weight, % by weight, wt %, and the like are synonyms that refer to the concentration of a substance as the weight of that substance divided by the weight of the composition and multiplied by 100. Percentages and ratios are by weight unless otherwise so stated.

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise. All chemical structures provided in this application contemplate and include every possible stereo isomers, conformational isomers, rotational isomers, and chiral alternative of the specific illustrated structure.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method of simultaneously reducing dust release and caking effects in a sample of mineral supplement, the method comprising the steps of:
contacting the mineral supplement with a composition comprising: sorbitan N-esters (of fatty acids), oil, and wax.

2. The method of claim 1 in which the oil comprises mineral oil and the wax comprises microcrystalline wax.

3. The method of claim 2 in which the sorbitan N-esters (of fatty acids) is selected from the list consisting of: sorbitan monostearate, sorbitan distearate, sorbitan tristearate, and any combination thereof.

4. The method of claim 2 in which the composition is a foam.

5. The method of claim 2 in which the sorbitan N-ester (of fatty acids) is up to 30% of the composition.

6. The method of claim 2 in which the microcrystalline wax is no more than 30% of the composition.

7. The method of claim 2 in which the composition is no less effective as a dust control agent than a similar composition that contains a more hydrophobic sorbitan than sorbitan N-stearate.

8. The method of claim 2 in which the composition is no less effective as a dust control agent than a similar composition that contains a more hydrophobic stearate than sorbitan N-stearate.

9. The method of claim 2 in which the sorbitan N-esters (of fatty acids) is sorbitan N-stearate.

10. The method of claim 2 in which the sorbitan N-esters (of fatty acids) is the reaction product of an esterification reaction using a stearic fatty acid.

11. The method of claim 2 in which the composition is a liquid.

12. The method of claim 2 in which the composition excludes the presence of metal stearates.

13. The method of claim 2 in which the mineral supplement is mineral fertilizer.

14. A method of simultaneously reducing dust release and caking effects in a sample of mineral supplement, the method comprising the steps of:
contacting the mineral supplement with a composition comprising: sorbitan N-esters (of fatty acids), mineral oil, and microcrystalline wax, the composition being applied as a foam.
